(19) United States
(12) Patent Application Publication
(10) Pub. No.: US 2006/0125797 A1
(43) Pub. Date: Jun. 15, 2006

(54) Automated teller machine

(75) Inventor: Alexander W. Whytock, Perthshire (GB)

Correspondence Address: MICHAEL CHAN;NCR CORPORATION, 1700 SOUTH PATTERSON BLVD, DAYTON, OH, 45479-0001, US

(73) Assignee: NCR Corporation

(21) Appl. No.: 11/273,471

(22) Filed: Nov. 14, 2005

(30) Foreign Application Priority Data
Dec. 11, 2004 (GB) 0427204.3

(51) Int. Cl. G09G 5/00

(52) U.S. Cl. 345/173

(57) ABSTRACT

An Automated Teller Machine (ATM) comprises a user interface and an operator panel. The operator panel is in the form of a Graphic User Interface arranged to provide two or more modes of interaction for a user, including a windows based mode and a text based mode, by emulating the text based hardware.

### BACKGROUND

The present invention relates to an automated teller machine (ATM) and in particular to an operator interface for an automated teller machine.

In ATMs a device known as the operator panel is used to provide an interface that aids & guides operators through an ATM servicing, replenishment or diagnosis procedure.

Existing operator panels and ATM applications are rudimentary in terms of user interface i.e. text based display and physical keyboard input. These existing operator panels are being replaced with operator panels that support emerging multimedia applications that utilize animation, graphics, audio and video to aid & guide an operator through servicing, replenishment or diagnosis procedures.

Customers migrate from the existing to the new hardware either by purchasing new SST products or field based kits containing the new operator panels. However, if possible many customers would prefer to replace their hardware prior to changing their application software. This presents ATM manufacturers with the problem of how to utilize a single operator panel to support both text based and multimedia based applications.

### SUMMARY

It is among the objects of an embodiment of the present invention to obviate or mitigate one or more of the above disadvantages.

According to a first aspect of the present invention there is provided an operator panel for use in an automated teller machine (ATM), which is configured to support multimedia interface applications and to emulate text based applications.

Preferably the operator panel has a liquid crystal display with DVI connectivity.

Preferably the operator panel has a touch screen with USB connectivity.

Preferably the operator panel has stereo speakers with USB connectivity.

According to a second aspect of the present invention there is provided an automated teller machine (ATM) comprising an operator panel as described above.

Preferably the ATM further comprises a separate user interface for use by customers for the provision of services not associated with the servicing or replenishment of the ATM.

Preferably the ATM is configured such that the operator panel and user interface are operable at the same time thus allowing a customer to obtain one or more services from the ATM at the same time as an operator is replenishing or repairing the ATM.

According to a third aspect of the present invention there is provided a computer program including instructions for the control of an ATM operator panel, which when executed enables both the operation of the operator panel as a multimedia interface and the emulation of text based applications.

Preferably, the program is arranged to operate the operator panel in three modes including an existing operator panel emulation mode, a native mode and a windows desktop mode.

### BRIEF DESCRIPTION OF THE DRAWINGS

Embodiments of the present invention will now be described, by way of example, with reference to the accompanying drawings, in which:

FIG. 1 is a simplified schematic front view of a self-service terminal;

FIG. 2 is a block diagram showing internal modules in the terminal of FIG. 1;

FIG. 3 is a block diagram of the hardware platform for an operator panel in accordance with an embodiment of the present invention;

FIG. 4 is a block diagram of the software components of an operator panel in accordance with the present invention;

FIG. 5 is a block diagram illustrating the operator panel operating in existing operator panel Emulation Mode;

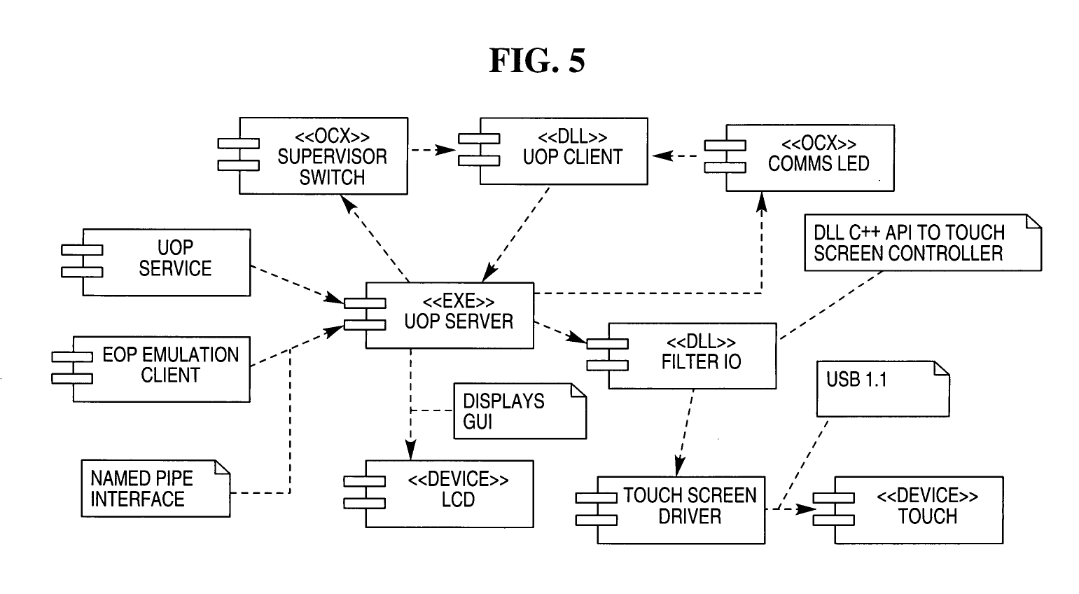

FIG. 6 is a block diagram illustrating the operator panel operating in native mode; and

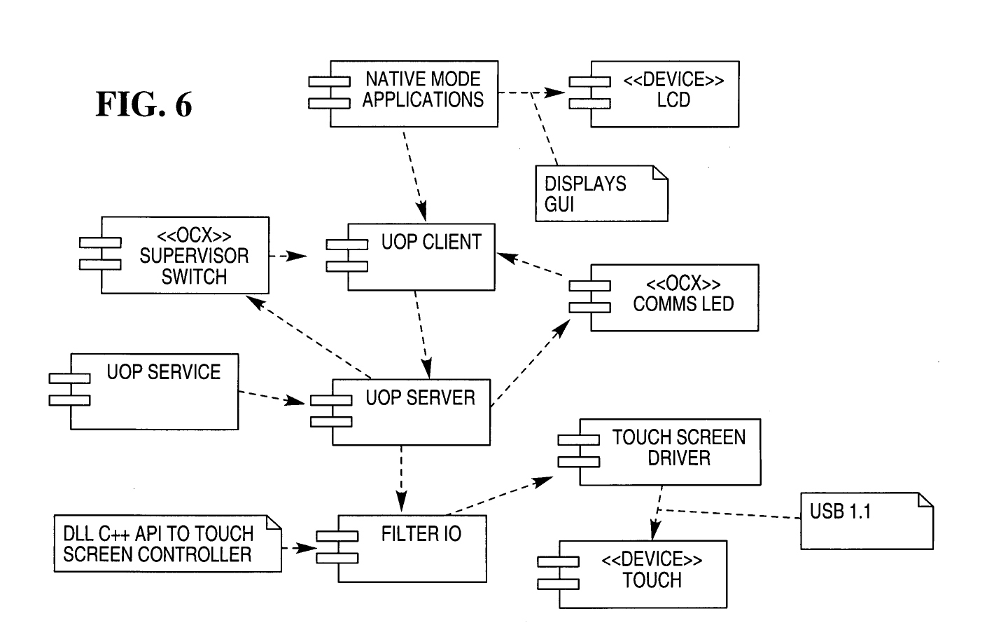

FIG. 7 is a block diagram illustrating the operator panel operating in desktop mode.

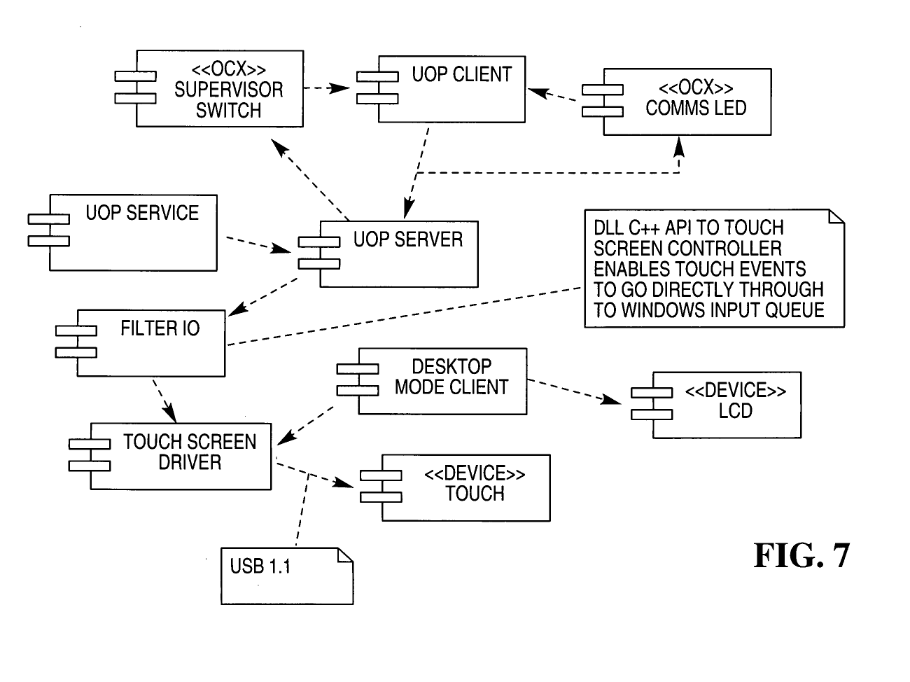

### DETAILED DESCRIPTION

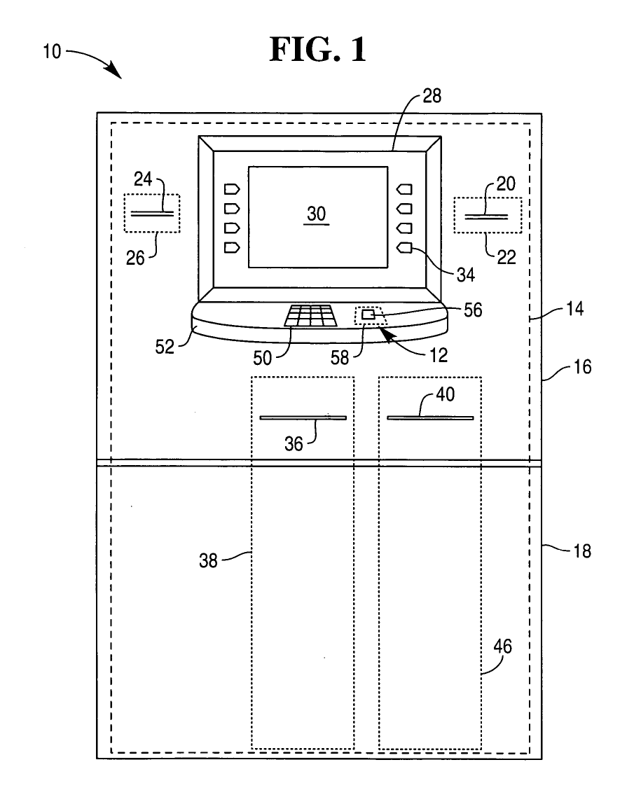

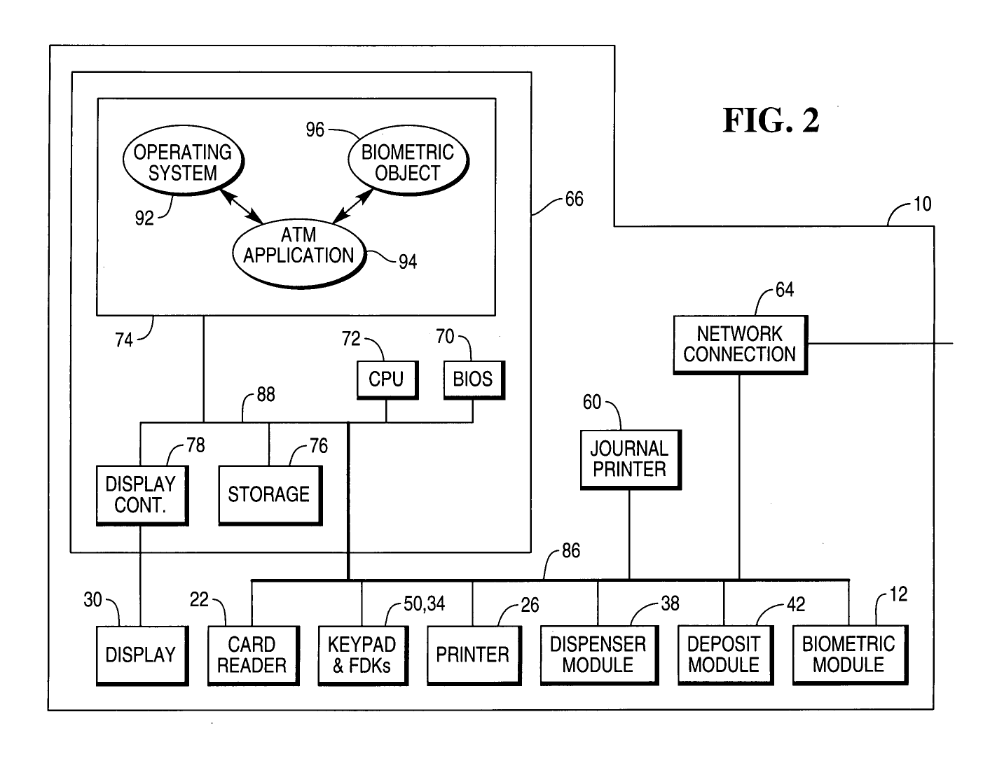

Reference is now made to FIGS. 1 and 2, which show a self-service terminal 10 in the form of an automated teller machine (ATM), which may be operated with a panel in accordance with the present invention. The ATM 10 has a chassis 14 to which is pivotably coupled a plastic fascia 16 covering an upper portion of the chassis 14. A door 18 is hingably coupled to a lower portion of the chassis 14. When the fascia 16 is hinged open and the door 18 is swung open, an operator can gain access to modules located within the ATM 10.

The fascia 16 provides a user interface to allow a user to interact with the ATM 10.

The term “user” in this description is intended to mean a customer who uses the ATM in order to utilize one or more of the services provided by the ATM. The term “operator” is intended to mean an engineer or other suitable person who interacts with the ATM so as to service, replenish or monitor the operation of the ATM in some way.

In particular, the fascia 16 has apertures aligning with modules mounted in the chassis 14 when the fascia 16 is pivoted to the closed position. The fascia 16 defines: a card reader slot 20 aligning with a card reader module 22 mounted within the chassis 14; a receipt printer slot 24 aligning with a receipt printer module 26 mounted within the chassis 14; a display aperture 28 aligning with a combined display 30 and associated function display keys (FDKs) 34 mounted as a module within the chassis 14; a dispenser slot 36 aligning with a dispenser module 38 mounted within the chassis 14; and a deposit aperture 40 aligning with a deposit module 42 mounted within the chassis 14.

The fascia 16 also includes an encrypting keypad 50 mounted on a shelf portion 52 extending outwardly from beneath the display aperture 28. The encrypting keypad 50 also receives input from the FDKs 34.

The biometric module 12 is mounted in the shelf portion 52 and includes (i.) a sensor 56 for receiving a human finger and for capturing fingerprint details, and (ii.) an interface 58 for encrypting and relaying a captured fingerprint image. The sensor 56 protrudes through an aperture in the shelf portion 52, and the interface 58 is mounted behind the shelf portion 52. The biometric sensor 56 is a Fingerloc (trade mark) AF-S2 fingerprint sensor, available from Authentec, Inc., P.O. Box 2719, Melbourne, Fla. 32902-2719, U.S.A.

Internally, the ATM 10 also includes a journal printer module 60 for creating a record of every transaction executed by the ATM 10, a network connection module 64 for accessing a remote authorisation system (not shown), and a controller module 66 (in the form of a PC core) for controlling the operation of the ATM 10, including the operation of the modules.

The controller 66 comprises a BIOS 70 stored in non-volatile memory, a microprocessor 72, associated main memory 74, storage space 76 in the form of a magnetic disk drive, and a display controller 78 in the form of a graphics card.

The display module 30 is connected to the controller module 66 via the graphics card 78 installed in the controller module 66. The other ATM modules (12, 22, 26, 34, 38, 42, and 50) are connected to the ATM controller 66 via a device bus 86 and one or more internal controller buses 88.

In use, the main memory 74 is loaded with an ATM operating system kernel 92, an ATM application 94, and a biometric capture object 96. As is well known in the art, the operating system kernel 92 is responsible for memory, process, task, and disk management. The ATM application 94 is responsible for controlling the operation of the ATM 10. In particular, the ATM application 94 provides the sequence of screens used in each transaction (referred to as the transaction flow); monitors the condition of each module within the ATM (state of health monitoring); and obtains authorisation for transactions from a remote transaction authorisation server (not shown).

The term “screen” is used herein to denote the graphics, text, controls (such as menu options), and such like, that are presented on an SST display; the term “screen” as used herein does not refer to the hardware (that is, the display) that presents the graphics, text, controls, and such like. Typically, when a transaction is being entered at an SST, a series of screens are presented in succession on the SST display, the next screen displayed being dependent on a user entry or activity relating to the current screen. For example, a first screen may request a user to insert a card; once a card has been inserted a second screen may invite the user to enter his/her PIN; once the final digit of the PIN has been entered, a third screen may invite the user to select a transaction; and so on.

The biometric capture object 96 receives data from the sensor 56, processes this received data, and forwards the processed data to the ATM application 94 for use in authenticating a user.

The controller 66 (particularly the biometric capture object 96) and the biometric module 12 together comprise a biometric system. The display 30 provides a feedback means for this biometric system.

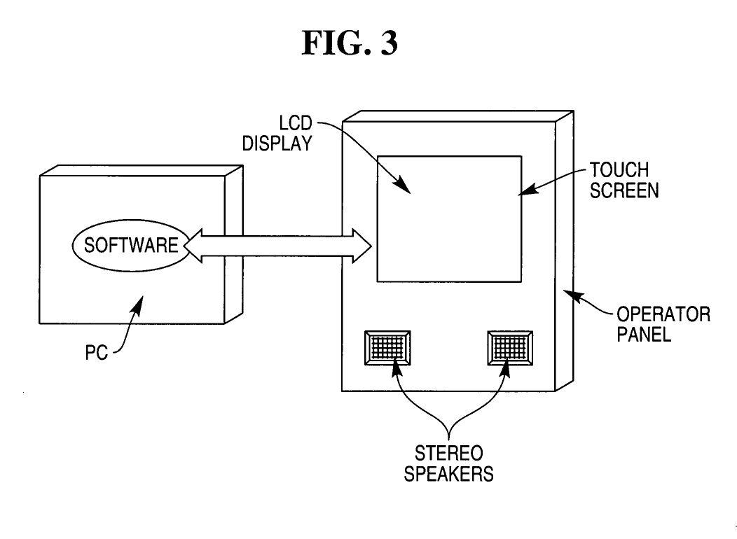

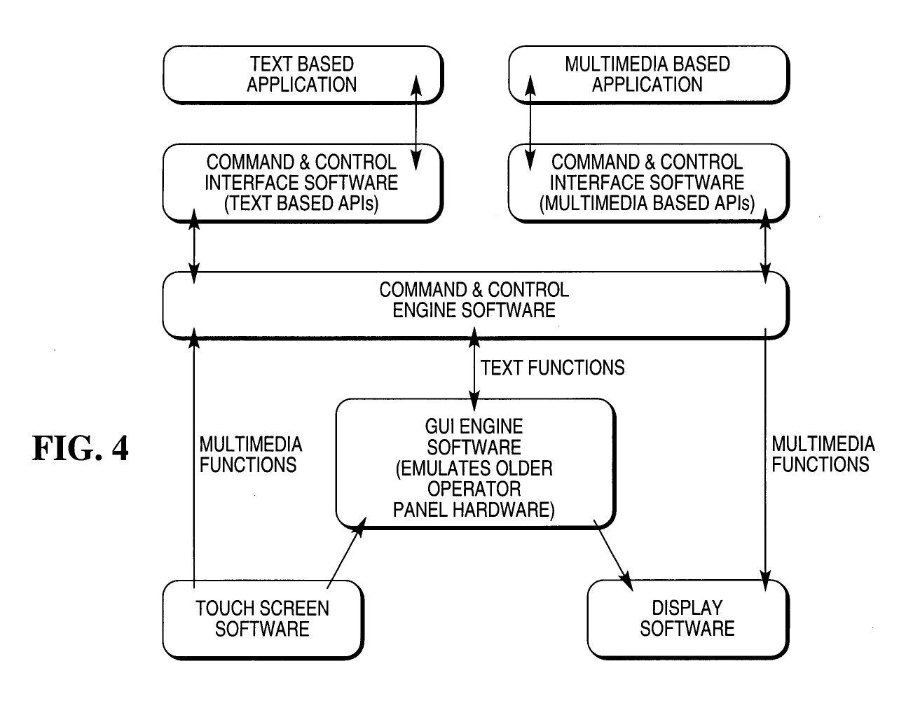

With reference to FIGS. 3 & 4 the software component shown in FIG. 3 provides the means for both text based and multimedia based applications to command and control the new operator panel hardware. FIG. 4 shows this software in more detail.

This software solution provides:

a) A Graphical User Interface (GUI) that emulates the text based hardware

b) Text based APIs

c) Multimedia based APIs

The package requires a proprietary USB touch screen controller that is compatible with the custom touch screen HID driver. The processor speed and type is dictated by the hardware requirements for the XP Core, but the processor must support the Microsoft® XP Professional operating system. The ATM XP core must also provide an available USB host side connector. The USB host must support version 1.1 at a minimum, 2.0 is preferred utilize the USB touch screen controller The operator panel software shall retrieve information from the operator panel touch screen through a USB connection and deliver the data to the XP Core applications via a regular dll propriety interface or instruct the touch screen to report as Windows mouse events. This interaction shall allow the applications on the XP Core to emulate the legacy operator panel, implement a new application utilizing the power of the SVGA touch screen to enhance the user experience, and allow users access to the full desktop functionality and utilize the touch screen as an input device to pass through to the XP operating system.

Modes of Operation

The operator panel server will operate in 3 modes. The modes dictate what the user sees and the routing of the information between the user and application consumers of the interfaces provided by the package. The three modes include:

Existing operator panel Emulation

Native Mode

Windows Desktop

The initial (first time ever following installation) default mode will be Native Mode. The operator panel Server will offer via the operator panel client C++ API methods that allow clients to get and set the next default mode following the next reboot of the XP Core. The default mode at startup shall be held in a registry value.

Existing Operator Panel Emulation

For existing operator panel Emulation mode the operator panel Server GUI is displayed in this mode. There shall be a series of named pipes that are programmatic connection interfaces. These pipes provide the communications mechanism between the Existing operator panel emulation client application(s).

The Operator panel Server will monitor the touch screen and report any touch events to the out-bound pipes and show the interaction via the GUI by changing the elements to respond to the touch (e.g. button changes to a pressed state). The operator panel server will monitor the inbound pipes and action any instruction (e.g. display char at location x and y in the textbox).

During operation in Emulation Mode the operator panel Server shall detect the operator panel Client C++ DLL being loaded and monitor the Supervisor Switch and Comms Indicator. It shall also detect requests to change the Operational Mode and action the request.

The display will become the secondary XP monitor in this mode.

If a change of mode is requested then any pending touch events are flushed prior to changing mode.

Native Mode

This is the initial default mode (first time ever following installation). The operator panel server GUI is not displayed in this mode and the Native mode application shall control the displaying of any graphical elements. The operator panel server will monitor the touch screen and report any touch events to the operator panel Client DLL. During operation in Native Mode the operator panel Server shall detect the C++ DLL being loaded and monitor of the Supervisor button and Comms Indicator. It shall also detect requests to change the Operational Mode and action the request.

The display will become the secondary XP monitor in this mode.

If a change of mode is requested then any pending touch events are flushed prior to changing mode.

Windows Desktop

The operator panel server GUI is not displayed in this mode. It shall detect requests to change the Operational Mode and action the request. It shall monitor & report touch screen propriety events as standard Windows mouse events by requesting the touch screen driver to forward the events to the windows message queue as normal touch events.

The display will become the primary XP monitor in this mode.

If a change of mode is requested then any pending touch events are flushed prior to changing mode.

When in use by an operator, for example, an ATM currency cassette or receipt printer can be replenished utilizing the operator panel to provide operator instructions. This and any other operation of the operator panel, by an operator, will not prevent the use of the ATM by a user or customer.

Various modifications may be made to the above-described embodiments within the scope of the present invention, for example, different colours may be used.

### APPENDIX 1

1.1 End User Interfaces

The EXISTING OPERATOR PANEL Emulation mode of the OPERATOR PANELServer application shall have a GUI visible to the end user. In Native mode and Windows Desktop mode the GUI shall be hidden. The GUI shall emulate the EXISTING OPERATOR PANEL with graphical elements. The layout shall look like the following:

[image]

1.1.1 Existing Operator Panel Emulation

1.1.1.1 Text Box

[image]

Purpose: To display the characters send to the OPERATOR PANELServer via the named pipes
Inputs: Single character data in the hex range of 0x00 to 0xbf, specified in the Universal Operator Panel Application Programming Interface document, see Section 2—reference #3.
Processing: Command and data shall be received via the named pipes inside the OPERATOR PANELServer. The display shall be 16 rows×32 columns. Each character shall be displayed in the row and column specified.
Outputs: The character at the current x, y position

Function Display Keys [image]
Purpose: To select a row of text from within the text box as a user selection
Inputs: User input clicking the FDK on the touch screen
Processing: Determine which FDK was pressed, and send the key code data that uniquely identifies which FDK was hit, over the keyboard pipe to the EXISTING OPERATOR PANEL Client.
Outputs: EXISTING OPERATOR PANEL Client is informed that a specific FDK was pressed

Alignment of Keys The FDKS shall be aligned with the following text Box rows.

TABLE 1
FDK Alignment Table

| FDK Left | Row | FDK Right |
|---|---|---|
| | 1 | |
| | 2 | |
| | 3 | |
| | 4 | |
| | 5 | |
| | 6 | |
| FDK Left 1 | 7 | FDK Right 1 |
| | 8 | |
| | 9 | |
| FDK Left 2 | 10 | FDK Right 2 |
| | 11 | |
| | 12 | |
| FDK Left 3 | 13 | FDK Right 3 |
| | 14 | |
| | 15 | |
| FDK Left 4 | 16 | FDK Right 4 |

1.1.1.2 16 Key Keypad [image]
Purpose: Accept a key press for keys 1-16 and send the key code to the client via pipe
Inputs: User touch screen down on key location
Processing: Determine which key was press and transmit the unique key code over pipe to EXISTING OPERATOR PANEL client.
Outputs: EXISTING OPERATOR PANEL Client is informed that a specific key on the keypad was pressed
   1.1.1.3 16 Key Keypad Configurability
Purpose: The characters on or on the side of the keys must be configurable to support multiple languages
Inputs: OPERATOR PANEL Keypad text strings from the registry
Processing: Read the registry information and display the strings on the keys appropriately. A bit map will be provided with the appropriate text.
Outputs: GUI shows the strings on or beside the keypad buttons appropriate for each language
   1.1.1.4 Supervisor Switch [image]
Purpose: The emulation mode GUI on the OPERATOR PANELServer needs to be able to change the mode between In Service and Supervisor Mode.
Inputs: User GUI interaction
Processing: Determine if the user down event is on the Supervisor button if so then change mode.
Outputs: Send SupervisorModeChangeEvent to all clients and set the Registry key to the new value. Change the direction the knob points to the correct supervisor state.
   1.1.1.5 Communication Status [image]
Purpose: To display the communication status of the system
Inputs: Pulse width and period data in milliseconds and then a pulse start or stop
Processing: When the Pulse start command is received via the C++ API, flash the yellow Comms led for <pulse width> number of milliseconds and turn off for (period minus pulse width) milliseconds and repeat until the stop command is received.
Outputs: Flashing yellow LED
   1.1.1.6 LEDS [image]
   1.1.1.6.1 Error Led
Purpose: To display status of EXISTING OPERATOR PANEL Client is in an error condition
Inputs: Request to turn LED off or on from the EXISTING OPERATOR PANEL client
Processing: Accept command from LED client over the Indicator pipe and do the action requested to the LED.
Outputs: Illuminated Red LED or LED turned off
   1.1.1.6.2 In Service
Purpose: To display In Service mode status of EXISTING OPERATOR PANEL Client
Inputs: Request to turn LED off or on from the EXISTING OPERATOR PANEL client
Processing: Accept command from LED client over the Indicator pipe and do the action requested to the LED.
Outputs: Illuminated green LED or LED turned off
   1.1.1.6.3 Supervisor
Purpose: To display Supervisor mode status of EXISTING OPERATOR PANEL Client
Inputs: Request to turn LED off or on from the EXISTING OPERATOR PANEL client
Processing: Accept command from LED client over the Indicator pipe and do the action requested to the LED.
Outputs: Illuminated green LED or LED turned off
   1.1.1.7 GUI Layout
Purpose: The layout shall mimic the legacy EXISTING OPERATOR PANEL.
Inputs: None
Processing: If screen resolution changes the application should adjust to the new screen size appropriately. It
shall always be maximized to the screen size taking up the whole screen and covering the task bar.
Outputs: A GUI that has a very similar look and feel to the legacy EXISTING OPERATOR PANEL
   1.1.1.8 GUI Modes
Purpose: The GUI must be displayed in Emulation mode and must be hidden in all other modes
Inputs: Mode change request
Processing: Command and data shall be received via the named pipes inside the OPERATOR PANELServer.
Outputs: GUI hidden from user or GUI displayed to user upon mode change
   1.1.1.9 Mouse Cursor Removal in Emulation Mode
Purpose: The user shall not see the mouse cursor in emulation mode because it would entice or make them expect to use the mouse to do the GUI interactions. A OPERATOR PANEL Client C++ API shall be added to make removal of the cursor easy for Native Mode applications.
Inputs: None
Processing: When the OPERATOR PANELServer is in Emulation mode or Native mode make the cursor transparent
Outputs: Mouse cursor is not visible to the end user

What is claimed is:

1. An operator panel for use in an automated teller machine (ATM), which is configured to support multimedia interface applications and to emulate text based applications.

2. An operator panel as claimed in claim 1, having a liquid crystal display with DVI connectivity.

3. An operator panel as claimed in claim 1, having a touch screen with USB connectivity.

4. An operator panel as claimed in claim 1, having stereo speakers with USB connectivity.

5. An operator panel as claimed in claim 1, which is adapted for operation in three modes of operation including an existing operator panel emulation mode, a native mode and a windows desktop mode.

6. An automated teller machine (ATM) comprising:
an operator panel which is configured to support multimedia interface applications and to emulate text based applications.

7. An automated teller machine as claimed in claim 6, further comprising a separate user interface for use by customers for the provision of services not associated with the servicing or replenishment of the ATM.

8. An automated teller machine as claimed in claim 7, wherein the operator panel and user interface are operable at the same time thus allowing a customer to obtain one or more services from the ATM at the same time as an operator is replenishing or repairing the ATM.

9. An automated teller machine as claimed in claim 6, wherein the operator panel is adapted for operation in three modes of operation including an existing operator panel emulation mode, a native mode and a windows desktop mode.

10. An automated teller machine (ATM) comprising:
a user interface; and
an operator panel in the form of a Graphic User Interface arranged to provide two or more modes of interaction for a user, including a windows based mode and a text based mode, by emulating the text based hardware.

11. An automated teller machine as claimed in claim 10, further comprising a separate user interface for use by customers for the provision of services not associated with the servicing or replenishment of the ATM.

12. An automated teller machine as claimed in claim 11, wherein the operator panel and user interface are operable at the same time thus allowing a customer to obtain one or more services from the ATM at the same time as an operator is replenishing or repairing.

13. An automated teller machine as claimed in claim 10, wherein the operator panel is adapted for operation in three modes of operation including an existing operator panel emulation mode, a native mode and a windows desktop mode.

14. A computer program including instructions for the control of an ATM operator panel, which when executed enables both the operation of the operator panel as a multimedia interface and the emulation of text based applications.

15. A computer program as claimed in claim 14, arranged to operate the operator panel in three modes including an existing operator panel emulation mode, a native mode and a windows desktop mode.
